(19) United States
(12) Patent Application Publication
(10) Pub. No.: US 2020/0349218 A1
(43) Pub. Date: Nov. 5, 2020

(54) METHOD FOR IDENTIFYING DISCRETE URYSOHN MODELS

(71) Applicants: Andrew Polar, Duluth, GA (US); Michael Poluektov, Coventry (GB)

(72) Inventors: Andrew Polar, Duluth, GA (US); Michael Poluektov, Coventry (GB)

(21) Appl. No.: 16/920,708

(22) Filed: Jul. 5, 2020

Related U.S. Application Data
(63) Continuation of application No. 15/998,381, filed on Aug. 11, 2018.

(51) Int. Cl. G06F 17/16; G06F 17/11

(52) U.S. Cl. CPC G06F 17/16; G06F 17/11

(57) ABSTRACT

A computationally inexpensive and stable method for real-time identification of multiple-input Urysohn models, designed and intended for usage in machine learning processes of robotic devices.

### CROSS-REFERENCES TO RELATED APPLICATIONS

This is a continuation of application Ser. No. 15/998,381, Filed Aug. 11, 2018, now abandoned.

### FEDERALLY SPONSORED RESEARCH OR DEVELOPMENT

Not Applicable

### SEQUENCE LISTING OR A COMPUTER PROGRAM

Not Applicable

### BACKGROUND OF INVENTION

### Field of Invention

This invention can be considered as a machine learning method for particular types of robotic devices, which require and use in their logic the dynamic properties of the controlled object. The convenient way to explain the reason for having such machine learning method is to compare a device operation to a human control. The example can be a simple U-turn of a car. The human driver does it by coordinated usage of three inputs: the accelerator (automatic transmission is assumed), the breaks and the steering wheel. For a successful maneuver, the driver should consider the dynamic properties of the car and the environmental factors. When a robotic device performs the same maneuver in a driverless car, it necessarily should use the digital dynamic model. This particular case may not need a sophisticated model, it can be implemented as a sequence of logic operations, look-up tables, algebraic formulas, etc.; but the dynamic properties must be incorporated into the control system in one way or another. This invention is a method of so-called self-training or machine learning for such robotic devices. The target systems are not necessarily transport vehicles, such as unmanned planes, driverless cars or boats, they can also be automated production lines, radar positioning systems or any other devices, where actuators must operate in accordance with the dynamic properties of the controlled object. The invention is limited to only those dynamic systems that can be described by the discrete Urysohn model (further referred to as the Urysohn model for simplicity) with the required for the control purposes accuracy.

### Prior Art

This invention is intended for implementation in the robotic devices, which are designed to monitor physical objects in real-time during their normal operations. The modern equipment for such devices is all digital. The inputs and outputs are series of numbers delivered to the processor. The actual measured signals are continuous processes, such as temperatures, pressures, positions of moving parts, angular velocities, etc.; but they are presented as sequences of numbers at the outputs of analog-digital converters. The time interval between the adjacent values is usually chosen small enough, in order to assume that the real signal does not change much within this time interval.

The analog-digital converters return a code related to a real value. These codes are usually calibrated—they are associated with the real values by applying a scaling, while also compensating for sensors' errors. For example, a temperature sensor, with a measurement error of ±2° C., can be placed in a glass of ice water and a glass of boiling water, in order to associate codes with +2° C. and +100° C. Such sensor may require only around 30 different codes for representation of the signal from 0° C. and +100° C., and having more codes does not add accuracy due to the measurement error of the sensor. Since we consider robotic devices with the programmed logic, we are free in choosing integers associated with instantaneous input and output values and in our further explanation they are the sequential integers (e.g. 1, 2, 3, . . . ), assuming a proportionality between the codes and the actual values.

In the light of our definitions and the format of the input-output values, we can describe the model of a deterministic dynamic system with one input as a function, which converts a finite sequence of input integers, collected within the preceding time, into an output scalar. In this invention, a particular case of such function is considered—the Urysohn model. One example is shown in FIG. 1, where U is a two-dimensional array and x is the integer input. Index j denotes the sequential time moments, at which inputs x are collected. If we would like to build such model (further referred to as the identification process), having a large set of inputs and outputs, we can combine the unknown elements of array U into a system of linear algebraic equations and solve it. However, this is only a theoretical opportunity that meets a lot of impediments on its way, which will be explained further in text.

The closest to this invention prior art, which deals with model in FIG. 1, is the Ph.D. thesis of one of the authors (A. R. Poluektov, 1990). The method, suggested in the prior art, relies on recording long sequences of inputs and outputs and on validating them prior to the identification. The fragments that do not qualify for identification purposes should be removed and valid fragments should be merged. Unfortunately, this part is the most complicated and error-prone, because, when implemented in a control system of an unmanned object, it should cover any unexpected data set. Even when large enough data set passes the validation, it is not the end of all problems. As it is shown in the thesis, the systems of linear algebraic equations, which must be solved during the identification, always have an infinity of solutions or no solution. If the solution is obtained, it is sensitive to small errors in the data. Such types of mathematical problems can be resolved by a human specialist in computational methods, using a regular laptop and some computational software, but cannot be easily resolved in an unmanned system. The research published in the thesis experimentally confirmed that such robotic systems can be successfully created and used, but the design of such robotic systems, due to the above-listed reasons, is complicated, time consuming and expensive.

The closest to the Urysohn model is the Hammerstein model, which is a particular case of the Urysohn model. Unfortunately, it has a simpler structure and fewer capabilities to describe the dynamics of the objects. We can mention several U.S. patents covering the identification of the Hammerstein model, which highlights the need of the industry in such methods (U.S. Pat. Nos. 8,620,631, 8,346,712, 8,346,711, 8,346,693, 8,260,732). These patents cannot be used for the identification of the Urysohn model, as it has significant differences and is more complex. However, the reverse is possible - the Urysohn model can be used instead of the Hammerstein model, without any changes and can even be simplified, i.e. reduced in size.

### OBJECTS AND ADVANTAGES

This invention offers a computationally stable method for constructing models of nonlinear objects, which can be described by the Urysohn model, with multiple inputs as opposed to prior art. The method is designed to calculate the model parameters by automatic processing of the sensors' readings by the robotic module in real time, during a regular operation of the controlled object. The computation is conducted as successive modifications of the model parameters. The advantages, introduced by this invention, are:

a) the method is applicable to the objects with multiple inputs in the same way as for the single-input objects;

b) it is computationally inexpensive, stable and robust with respect to data errors;

c) it requires a small number of computational operations at each model improvement step, such that the parameters can be identified in real-time;

d) it does not require solving a large system of linear algebraic equations with an ill-conditioned matrix;

f) in the case when the identification is repeated multiple times for different data sets, but for the same object, the obtained models converge to the same result, which means that when the model is found, it is unique.

g) the training of the robotic module, which performs the identification, can be interrupted and resumed multiple times until the required accuracy is achieved.

### BRIEF SUMMERY OF INVENTION

This invention provides a method for identifying the Urysohn model with multiple inputs by few elementary computational steps using recorded input and output values. The method is designed and intended for usage in robotic devices, which perform it in real time. The result is achieved by modification of the model parameters, which are selected according to the inputs, each time a new set of measured values is obtained.

### BRIEF DESCRIPTION OF SEVERAL VIEWS OF THE DRAWINGS

FIG. 1 shows the Urysohn model for the case of integer argument x.

FIG. 2 shows the Urysohn model of the object with two integer inputs x and y.

FIG. 3 shows the sequences of two inputs and the corresponding output scalar of a hypothetical dynamic system used for the illustration of the method.

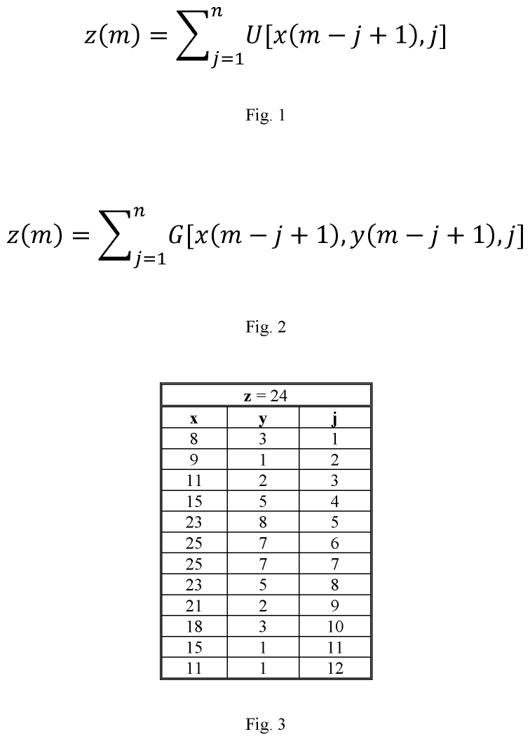

### DETAILED DESCRIPTION—PREFERRED EMBODIMENT

The goal of this invention is defined in the previous sections. For the case of two inputs, the Urysohn model is represented by three-dimensional array G, shown in FIG. 2. The generalization of the model for three and more inputs trivially follows from the two-input model. If the idea of the prior art method is applied (i.e. building a system of linear algebraic equations with unknown elements of array G), as discussed previously, the size of such system, the need for the data validation and the sensitivity to small errors make the identification unrealistic, specifically, in a memory of a robotic device. However, these problems can be avoided and the model can be built using a different idea, relying on processing short data fragments concurrently with data readings.

The proposed algorithm operates as follows. Suppose there is a current approximation of the Urysohn model. After each reading of new measured input and output values, first, the result of the model is calculated as the sum of the corresponding elements of array G. Then, the difference between the real (measured) output and the calculated (model) output is evaluated. Finally, this difference is multiplied by a noise-filtering parameter taking a value from interval (0.0, 1.0), then it is divided by the number of addends in the sum (n in FIG. 2) and the result is added to each element of G that was involved in the computation of the model output. Afterwards, new input and output values are read and the process is repeated. Assuming that robotic device performs real-time observation of the physical object during its normal operation and conducts identification concurrently with data reading, than the model quickly evolves into accurate statistically-obtained array G. At the start of the process, before any data is collected, all elements of array G can be taken to be zeros as the initial guess. As we can see, the operations of correcting the model are mathematically simple and not much different from a simple computing of an average value. The theoretical background of this method is published by the authors in a peer-reviewed mathematical journal (M. Poluektov, 2020), where convergence, stability and uniqueness of the solution are strictly proven. Uniqueness means that if the identification process is repeated multiple times for the same physical object, it will always converge to the same model (with a possible insignificant difference due to electric noise and sensors' inaccuracies).

For an illustrative purpose, let's consider an example. In the table of FIG. 3, we can see an example of two inputs, recorded within the preceding time, and the output (z=24) fully defined by these finite-length fragments of two inputs. According to the considered properties, our dynamic system must be described by array G with dimensionality equal to a number of inputs plus one, i.e. three. Also, output z=24must be equal to the sum of the elements of array G, defined by the addresses in all rows G[8,3,1]+G[9,1,2]+G[11,2,3]+ . . . +G[11,1,12]. In case if the sum of all these elements is not equal to the output z=24, we correct these elements by adding a constant to each of them, which reduces the magnitude of the difference between the sum and the output. This operation is simply repeated for each new data fragment. The third column in the table of FIG. 3, which is index j from the formula in FIG. 2, is introduced for convenience and it is always the same sequence of the sequential integers for each new data fragment.

The size of the temporary data storage, needed for the identification, is small and is only equal to the memory length of the dynamic object. The identification process can be interrupted and resumed at any time. The inputs can be validated and, if not qualify, the identification step can be simply skipped. Array G must be preserved constantly, but since its size is small, it can be saved on a power-independent storage, when the robotic system shuts down.

If the Urysohn model is required after manufacturing of the robotic system, but prior to completion of the identification process, then the robotic device may be installed with an approximate model, which is improved afterwards in real-time during the normal operation of the controlled object.

The same improvement of the Urysohn model can be used for non-stationary objects or for compensating of slowly changing environmental factors. For example, the outputs of internal combustion engines depend also on the air temperature (besides inputs), but it is a slowly changing environmental parameter and the model accuracy can be slightly tuned for different weather conditions.

The claimed unobvious novelty is in representing the multiple-input Urysohn model as a multidimensional array with inputs used as addresses of the elements, sum of which equals the output. This simplifies the building of non-linear models by applying few arithmetic operations to each new set of input and output values that are processed in real time. The suggested method is developed specifically for the robotic devices and, according to USPTO 2019 Patent Eligibility Guidance, is not an abstract idea.

The granted U.S. Pat. Nos. 8,260,732, 8,346,693, 8,346,711, 8,346,712, 8,620,631 are chosen as protypes, because they patent similar purpose modeling methods for engineering systems but only for a less generic model.

### Description—Alternative Embodiment

When the identification is conducted as a real-time process by a robotic device for the normally functioning object, we expect inputs to be random. This means that sometimes not all values of array G can be identified. For example, assume that input x is given by a temperature sensor, which records integers from 1 to 100. During the identification procedure, the temperature did not vary in the entire range, and x took values between 21 and 49. In this case, the edge elements of array G are not determined. However, even partially known array G can be used as is. This is the unique feature of the dynamic models of such type. The model can be used even when it is known partially, which is not possible for models in the form of differential equations, nor for linear dynamic models. If we identified the model using the range from 21 to 49 for input x, we can compute an output for an input from this range. When x takes a value outside this range, the output is unknown; however, when it comes back to this range, the output again becomes computable.

Here is one example when we need such partially-known model. Assume that we have built a microprocessor system for diagnostics of a dynamic object. After we identified the model, we can predict the output having the model and the measured input. If the physical object has changed its dynamic properties, the computed output will not match recorded one. Having an ability to compute the fragments of an output signal is sufficient for such diagnostic purposes. Although the model is partially known and not all outputs can be computed, ones that are computed are accurate.

We claim:

1. A computerized method for real-time identification of multiple-input Urysohn models in a machine learning process of a robotic device, comprising executing on a processor the steps of:
(a) receiving an output scalar and finite-length input fragments as sequences of integers after rescaling of raw sensor readings;
(b) introducing an auxiliary array of integers, containing self-positioning indexes, with the size equal to the size of the finite-length input fragments;
(c) by navigating through the finite-length input fragments and the auxiliary array of integers, building a list of addresses, where each address is formed by grouping one element of the auxiliary array of integers with one element of each finite-length input fragment;
(d) having a current Urysohn model as an array with a dimensionality equal to the number of inputs plus one and the list of addresses built according to (c), modifying those elements of the current Urysohn model, which addresses are present in the list of addresses, by adding a constant that reduces the magnitude of a difference between the output scalar and a sum of elements, which belong to the list of addresses;
(e) repeating steps (a) through (d) for next output scalar and next finite-length input fragments, until magnitude of the difference, computed according to (d), between the output scalar and the sum of elements of the current Urysohn model falls and stays within expected limits.

2. A non-transitory computer readable medium for real-time identification of multiple-input Urysohn models in a machine learning process of robotic device, comprising instructions stored thereon, that when executed on a processor, perform the steps of:
(a) receiving an output scalar and finite-length input fragments as sequences of integers after rescaling of raw sensor readings;
(b) introducing an auxiliary array of integers, containing self-positioning indexes, with the size equal to the size of the finite-length input fragments;
(c) by navigating through the finite-length input fragments and the auxiliary array of integers, building a list of addresses, where each address is formed by grouping one element of the auxiliary array of integers with one element of each finite-length input fragment;
(d) having a current Urysohn model as an array with a dimensionality equal to the number of inputs plus one and the list of addresses built according to (c), modifying those elements of the current Urysohn model, which addresses are present in the list of addresses, by adding a constant that reduces the magnitude of a difference between the output scalar and a sum of elements, which belong to the list of addresses;
(e) repeating steps (a) through (d) for next output scalar and next finite-length input fragments, until magnitude of the difference, computed according to (d), between the output scalar and the sum of elements of the current Urysohn model falls and stays within expected limits.
